(19) United States
(12) Patent Application Publication
(10) Pub. No.: US 2015/0372935 A1
(43) Pub. Date: Dec. 24, 2015

(54) SYSTEM AND METHOD FOR MIGRATION OF ACTIVE RESOURCES

(71) Applicant: TELEFONAKTIEBOLAGET L M ERICSSON (PUBL), Stockholm (SE)

(72) Inventors: Mattias Åkervik, Kista (SE); Ruben Laguna-Macias, Sollentuna (SE); Dan Green, Upplands Vasby (SE); Ana Cunha, Taby (SE); Aitor Hernandez Herranz, Stockholm (SE)

(21) Appl. No.: 14/492,631

(22) Filed: Sep. 22, 2014

Related U.S. Application Data
(60) Provisional application No. 62/016,303, filed on Jun. 24, 2014.

(51) Int. Cl. H04L 12/911; H04L 29/08

(52) U.S. Cl. CPC H04L 47/70; H04L 67/10

(57) ABSTRACT

Embodiments of the present invention include a method and apparatus for identifying at least one resource to be migrated from a source system to a target system; creating at least one resource in the target system with similar properties as the at least one resource to be migrated from the source system; and migrating the at least one resource from the source system to the target system.

### CLAIM OF PRIORITY

This application claims the benefit of U.S. Provisional Application No. 62/016,303 filed on Jun. 24, 2014. The contents of this document are hereby incorporated by reference herein.

### TECHNICAL FIELD

The present invention relates in general to data processing systems. More particularly, and not by way of limitation, the present invention is directed to a system and method of migrating active resources between different data processing systems.

### BACKGROUND

“Cloud computing” generally refers to a type of network computing where a program or application executes on at least one or more networked computers as opposed to a local computing device such as a desktop or laptop computer, tablet computer, or a mobile phone. The program or application is configured in such a way that the execution of the program or application may be performed on one or more computers at the same time by utilizing “virtualization.” Through virtualization, one or more physical computers are configured into multiple independent “virtual” computers or “virtual machine.” The virtual computers function independently and appear to a user device to be a single physical computer.

Since virtual computers can be implemented by any number of physical computers, the physical computers can be physically moved or replaced with little or no noticeable effect to the user device accessing the virtual computers. If more or less processing capacity is required from a particular virtual computer, any number of physical computers can be added or subtracted to handle the increased or decreased processing capacity demands.

As demand for computing power grows, larger and larger number of physical computers are managed and maintained in facilities called “data centers.” A data center can include, among other things, a number of physical computers, redundant or backup power supplies, redundant data communications connections, environmental controls, and security systems. As the size of data centers increase, the power consumption of these data centers becomes a greater concern. Thus, there is a need to manage and allocate data center resources for energy efficiency, load balancing, improved availability, and maintenance.

Thus, it would be advantageous to have a system and method for the migration of active resources between data centers that overcomes the disadvantages of the prior art. The present invention provides such a system and method.

### SUMMARY

Advantages of the present invention include an ability to migrate active resources (e.g., a virtual machine) from a first management domain to a second management domain, which results in, among other things, increased energy efficiency and improved availability. Also, another advantage of the present invention includes an ability to migrate active resources between management domains that do not necessarily utilize a common computing platform.

### BRIEF DESCRIPTION OF THE DRAWINGS

In the following section, the invention will be described with reference to exemplary embodiments illustrated in the figures, in which:

FIG. 1A depicts a generalized view of a network according to an embodiment of the present invention;

FIG. 1B is a flowchart diagram illustrating a method of migrating active resources according to an embodiment of the present invention;

FIG. 1C is a flowchart diagram depicting a method of migrating active resources according to another embodiment of the present invention;

FIG. 1D is a flowchart diagram illustrating a method of migrating active resources according to another embodiment of the present invention;

FIG. 1E is a flowchart diagram depicting a method of migrating active resources according to another embodiment of the present invention;

FIG. 2 is a signal diagram depicting a method of migrating active resources according to an embodiment of the present invention;

FIG. 3A is a signal diagram illustrating a method of migrating active resources according to an embodiment of the present invention;

FIG. 3B is a signal diagram illustrating a method of migrating active resources according to an embodiment of the present invention;

FIG. 4 is a signal diagram depicting a method of migrating a flavor configuration according to an embodiment of the present invention;

FIG. 5 is a signal diagram illustrating a method of migrating an image configuration according to an embodiment of the present invention;

FIG. 6. is a signal diagram depicting a method of migrating a KeyPair configuration according to an embodiment of the present invention;

FIG. 7 is a signal diagram illustrating a method of migrating a volume configuration according to an embodiment of the present invention;

FIG. 8 is a signal diagram depicting a method of migrating a port configuration according to an embodiment of the present invention;

FIG. 9 is a signal diagram illustrating a method of migrating a network configuration according to an embodiment of the present invention;

FIG. 10 is a signal diagram depicting method of migrating active resources between two OpenStack instances according to an embodiment of the present invention;

FIG. 11 is a block diagram of a data processing system according to an embodiment of the present invention.

### DETAILED DESCRIPTION OF THE INVENTION

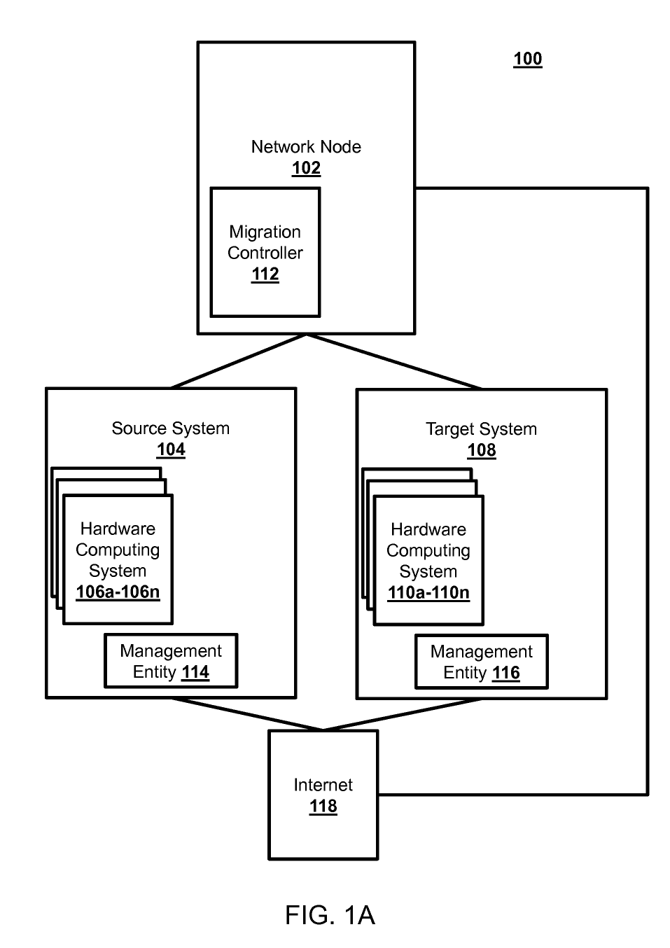

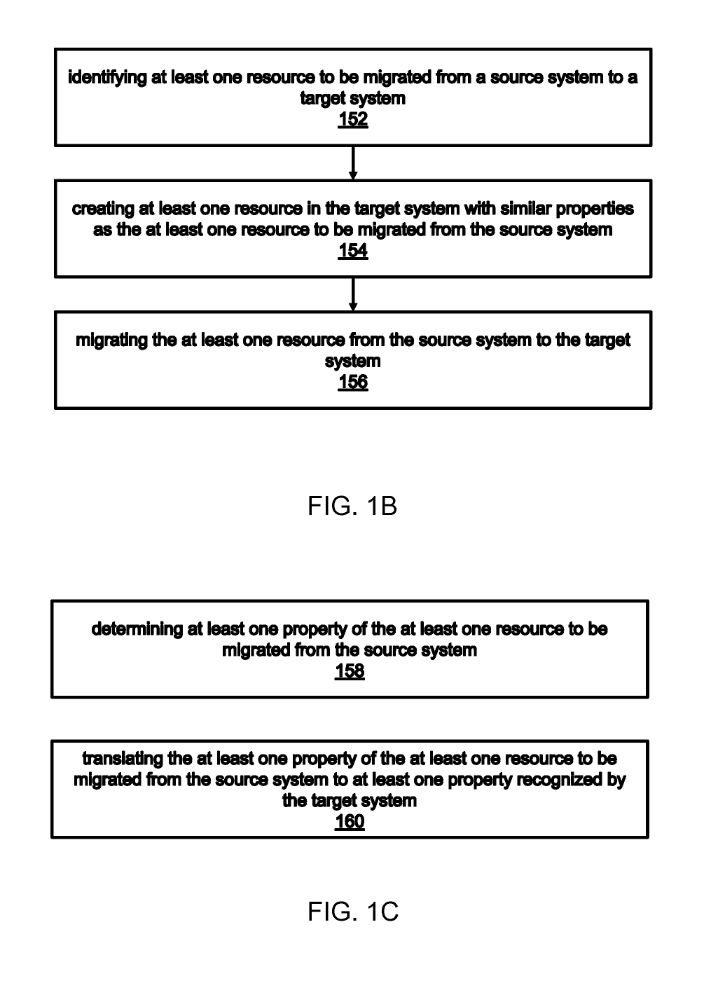

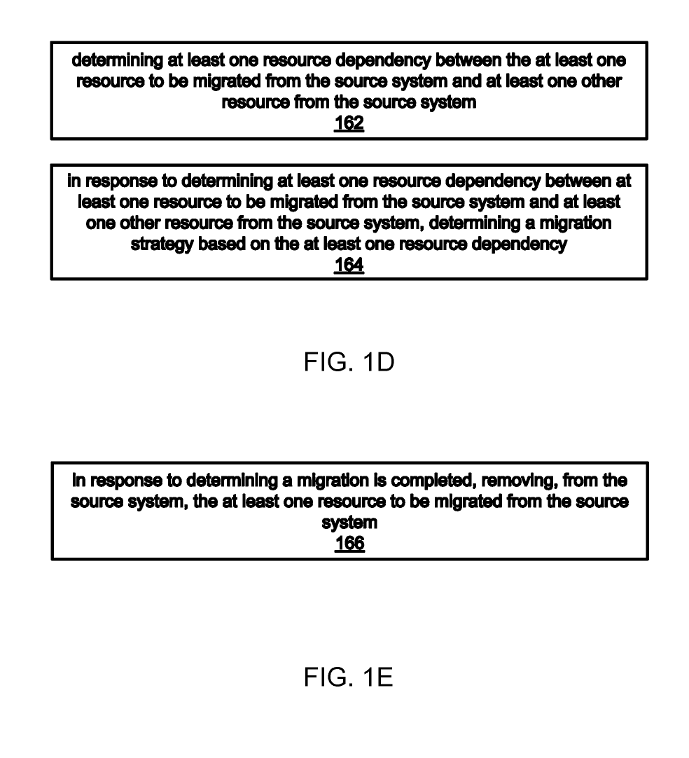

The methods described herein can be implemented in any appropriate type of data processing system or network supporting suitable communication standards and using any suitable components. Particular embodiments of the described methods may be implemented in a network such as illustrated in FIG. 1A.

FIG. 1A is a block diagram illustrating a general view of network 100, which includes a network node 102, a source system 104, a target (or “destination”) system 108, and Internet 118 according to an embodiment of the present invention. According to an embodiment of the present invention, source system 104 is a cloud computing system that includes dynamically scalable and virtualized resources that are used to provide services to users over a network such as Internet 118 or a local area network (LAN). As illustrated, network node 102, source system 104, and target system 108 can be connected to Internet 118, but can also be connected in different ways to different networks, local or otherwise.

Source system 104 also includes at least one hardware computing system 106a-106n that provides computing resources for source system 104. All of the resources of source system 104 are managed by a management entity 114, such as an instance of a cloud computing platform like, for example, OpenStack™, which is a trademark of the OpenStack Foundation. Thus, the resources of source system 104 are considered to be part of a first “management domain.”

Target system 108 is a cloud computing system that includes dynamically scalable and virtualized resources that are used to provide services to users over a network such as the Internet. Target system 108 also includes at least one hardware computing system 110a-110n that provides computing resources for target system 108. All of the resources of target system 108 are managed by a management entity 116, such as an instance of a cloud computing platform like, for example OpenStack™′ Thus, the resources of the target system 108 are considered to be part of a second “management domain.” Cloud computing platforms of source system 104 and target system 108 can be the same cloud computing platform, different versions of the same cloud computing platform, or different cloud computing platforms.

Network node 102 further includes a migration controller 112, which facilities migration of resources between source system 104 and target system 108 (or vice versa), as discussed herein in more detail. In other embodiments of the present invention, migration controller 112 could be further integrated in source system 104 or target system 108 (e.g., be integrated with the management entities in either source system 104 and/or target system 108).

The management entities of source system 104 and target system 108 include modules that are used to manage and automate pools of computer resources (e.g., processing power and storage capacity from hardware computer systems 106a-106n (in the source system 104) and hardware computer systems 110a-110n (in the target system 108) in order to implement virtual machine managers (VMM) or hypervisors to manage virtual machines (VM) in source system 104 and target system 108. Other modules of the management entities include modules that control storage, manage networking aspects of networking such as Internet Protocol (IP) addresses, encryption and identity services, and user interfaces for administration of cloud-based services.

Current available solutions for resource migration, offer the functionality between physical servers sharing the same management domain. For situations where a resource, such as a virtual machine (VM), should be moved to another management domain, the VM needs to be stopped, moved to the new management domain, and then started. Hence the main problem is that the service provided by the VM must be taken down during the migration. Reasons why such move is needed could be e.g., change the VMs geographical location, achieving better energy efficiency, load balancing, improved availability, or to perform a software or hardware upgrade in a certain data center.

The problem described above is solved by live migration, e.g. migration of an active resource, between two distinct management domains. This is enabled by creating a, as far as possible, identical resource in the target domain and letting the existing resource in the source domain take its place in the target domain. The selected active resource in the source domain is recreated with identical parameters (i.e. from a configuration perspective) in the target domain. Before the created resource in the target domain becomes active, the selected active resource in the source domain is live migrated into the target domain. This can be performed with, or without, the target domain's knowledge of the resource origin (i.e., an embodiment could be transparent to the target domain or not). If management entities of the source system and target system are not the same platform, version, or configuration, the migration controller may need to translate the parameters understood by the source system to parameters understood by the target system in order to create the “identical resource” in the target domain. For example, if the cloud computing platform of the target system provides additional functionality compared to the cloud computing platform of the source system, the migration controller determines, through a predetermined configuration transformation method, how the additional functionality should be configured for the resources to be migrated.

Thus, an advantage of the present invention enables relocation of resources between management domains with no or minimal service downtime. This could be used in a variety of scenarios, e.g. solving upgrade incompatibilities (migrating resources to a data-center with new software where upgrading the old software is not possible), geographical resource relocation, swap of data center vendor (e.g. move running resources from one vendor's data center to another vendor's data center), or optimize energy consumption when several data centers are co-located.

Embodiments of the present invention include a method of migrating active resources from a source system to a target system where the method includes a series of steps. With the first step, the resource (e.g., a VM) to be migrated from a source system (e.g., source system 104 of FIG. 1A) is identified by a migration controller (e.g., migration controller 112). When more than one resource is to be migrated, the migration controller identifies any possible inter-resource dependencies that put constraints on the resource migration order.

In a second step a resource is created in a destination (or target) system (e.g., target system 108 of FIG. 1A) with identical properties as the selected resource in the source system. This is done to enable the “plug-in” of the selected resource in source system into the target system. The migration controller may perform a translation of the properties of the selected resource in the source system to properties understood by the destination system.

A third step includes the actual migration procedure of the selected resource from the source system to the destination system.

A fourth step includes cleaning up the source system. This step is needed if the method is implemented transparently in the source system.

FIG. 1B is a flowchart diagram that illustrates a method of migrating active resources according to an embodiment of the present invention. The process begins at step 152, which illustrates a migration controller (e.g., migration controller 112 of FIG. 1A) identifying at least one resource (e.g., a VM) to be migrated from a source system (e.g., source system 104 of FIG. 1A) to a target system (e.g., target system 108 of FIG. 1A). When more than one resource is to be migrated, the migration controller identifies any possible inter-resource dependencies that constraints resource migration order (the order in which resources can be migrated from the source system to the target system).

The process continues to step 154, which depicts the migration controller creating at least one resource in the target system with similar properties as the at least one resource to be migrated from the source system. According to an embodiment of the invention, the creation of the resource in the target system with similar properties enables a “plug-in” of the selected resource in source system into the target system. The migration controller may perform a translation of the properties of the selected resource in the source system to properties understood by the target system, as discussed herein in more detail. Finally, the process ends at step 156, which illustrates the migration controller migrating the at least one resource from the source system to the target system.

FIG. 1C is a flowchart diagram that illustrates a method of migrating active resources according to another embodiment of the present invention. Step 158 illustrates a migration controller (e.g., migration controller 112 of FIG. 1A) determining at least one property of the at least one resource (e.g., a VM) to be migrated from the source system (e.g., source system 104 of FIG. 1A). Step 160 depicts the migration controller translating the at least one property of the at least one resource to be migrated from the source system to the at least one property recognized by the target system (e.g., target system 108 of FIG. 1A).

FIG. 1D is a flowchart diagram that depicts a method of migrating active resources according to another embodiment of the present invention. Step 162 illustrates a migration controller (e.g., migration controller 112 of FIG. 1A) determining at least one resource dependency between the at least one resource to be migrated from the source system (e.g., source system 104 of FIG. 1A) and at least one other resource from the source system. Step 164 illustrates the migration controller, in response to determining at least one resource dependency between at least one resource to be migrated from the source system and at least one other resource from the source system, determining a migration strategy based on the at least one resource dependency.

FIG. 1E is a flowchart diagram that depicts a method of migrating active resources according to another embodiment of the present invention. Step 166 illustrates a migration controller (e.g., migration controller 112 of FIG. 1A), in response to determining a migration is completed, removing, from the source system (e.g., source system 104 of FIG. 1A), the at least one resource (e.g., a VM) to be migrated from the source system.

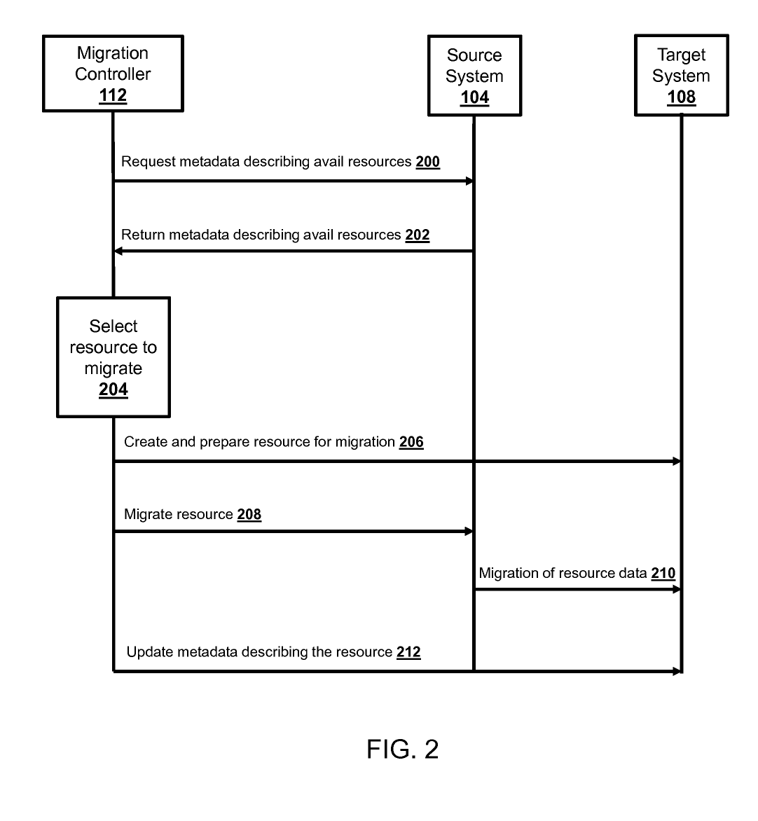

FIG. 2 is a signal diagram illustrating a method of migration of active resources according to an embedment of the present invention. More specifically, FIG. 2 illustrates the interaction between the migration controller, a first management domain or source system (e.g., source system 104 of FIG. 1A), and a second management domain or target system (e.g., target system 108 of FIG. 1A) during resource migration. A migration controller (e.g., migration controller 112 of FIG. 1A) can be used to implement embodiments of the present invention. A resource could be, e.g., a storage volume or a virtual machine.

The process begins at step 200, which illustrates the migration controller requesting metadata describing available resources from the source system. The request of the metadata is performed to select or determine which resources should be migrated and the order in which the migrations should be performed. The order in which the migrations should be performed should take into consideration, for example, inter-resource dependencies, which are described herein in more detail.

The process continues with step 202, which depicts the source system replying to the request with metadata that describes the available resources on the source system. The process continues at step 204, which illustrates the migration controller determining which resources should be migrated, according to preconfigured data associated with the resources. The migration controller then selects the next resource to be migrated. Dependencies between available resources in the source domain might require a certain resource migration order.

The process continues to step 206, which illustrates the migration controller creating, from a metadata point of view, an identical copy of the selected resource in the target system. For example, if the selected resource is a virtual machine (VM), examples of identical metadata include Media Access Control (MAC) addresses of the virtual Network Interface Controllers (NICs) connected to the VM and any Internet Protocol (IP) addresses assigned to the VM in the source system.

The process continues to step 208, which depicts the migration controller instructing the source system to begin the migration of the selected resource to the target system. At step 210, the source system initiates the resource migration to the target system, as instructed by the migration controller. When appropriate, any additional metadata describing the resource is added or modified for the migrated resource in the target system (step 212).

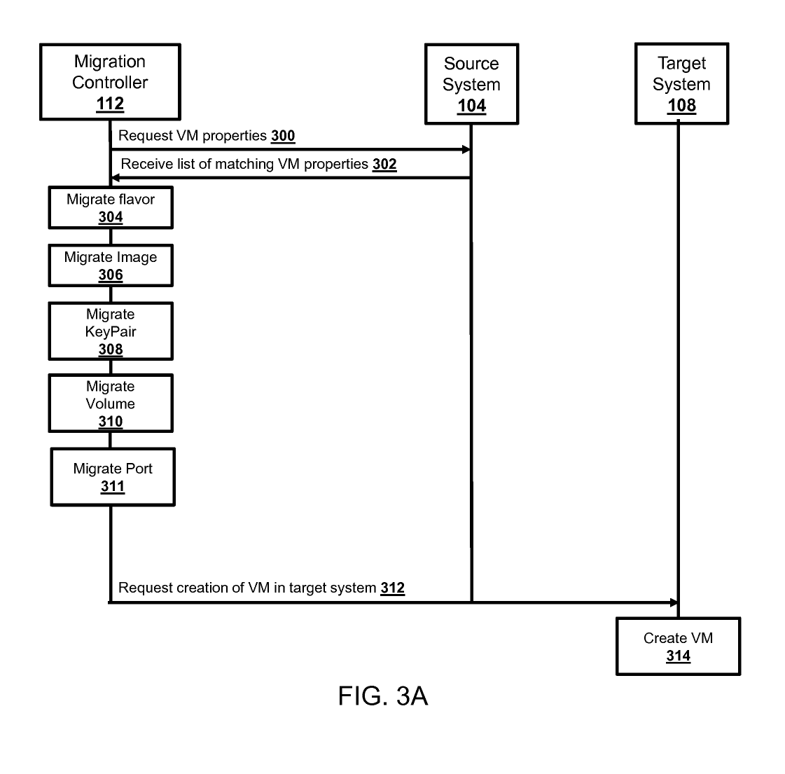

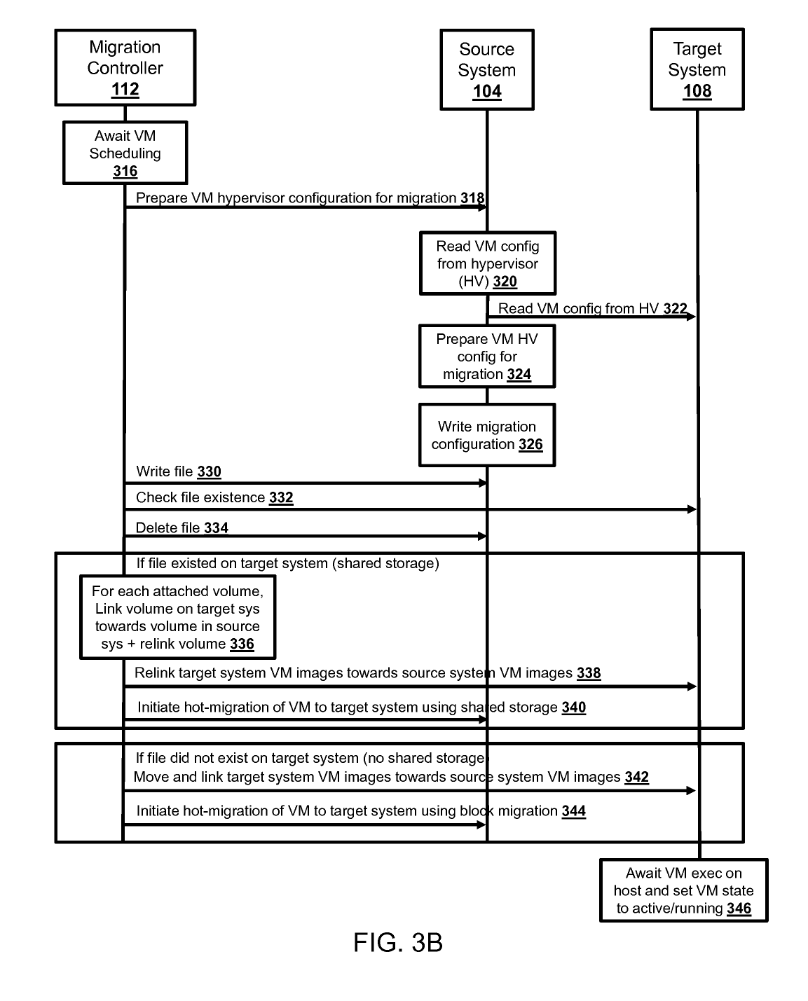

FIG. 3A-3B are signal diagrams that illustrate a more detailed depiction of a method of migrating active resources according to an embodiment of the present invention. As illustrated, a migration controller (e.g., migration controller 112 of FIG. 1A) controls the active migration of resources between a source system (e.g., source system 104 of FIG. 1A) and a target system (e.g., target system 108 of FIG. 1A). As previously discussed, the source system and target system are organized as a first management domain and a second management domain, respectively.

FIG. 3A-3B specifically discuss an embodiment of the present invention that supports the migration of a resource where the resource is a virtual machine. As discussed herein in more detail, a “virtual machine” (VM) is a software implementation of a machine (e.g., a computer system) that executes computer programs like a physical machine. A virtual machine may be a “system virtual machine” that provides a complete system platform executing a particular operating system (OS) or a “process virtual machine,” which is designed to run a single program and perform a single process.

Referring now to FIG. 3A, a migration controller (e.g., migration controller 112 of FIG. 1A) first collects VM properties regarding the VM to be migrated from a source system (e.g., source system 104 of FIG. 1A) to the target system (e.g., target system 108 of FIG. 1A). Step 300 illustrates the migration controller requesting the VM properties from the source system. One example of a VM property is the VM “flavor,” which includes compute resources, memory capacity, and storage capacity of a particular VM. The VM flavor specifies, for example, a number of virtual central processing units (VCPUs), an amount of random access memory (RAM), and amount of disk space for a root partition, an amount of disk space to use in an ephemeral disk partition, which is removed when the VM stops execution, an amount of swap disk space, an identifier (ID) of the flavor, and whether or not the flavor is publically accessible. Step 302 depicts the migration controller receiving the requested VM properties from the source system.

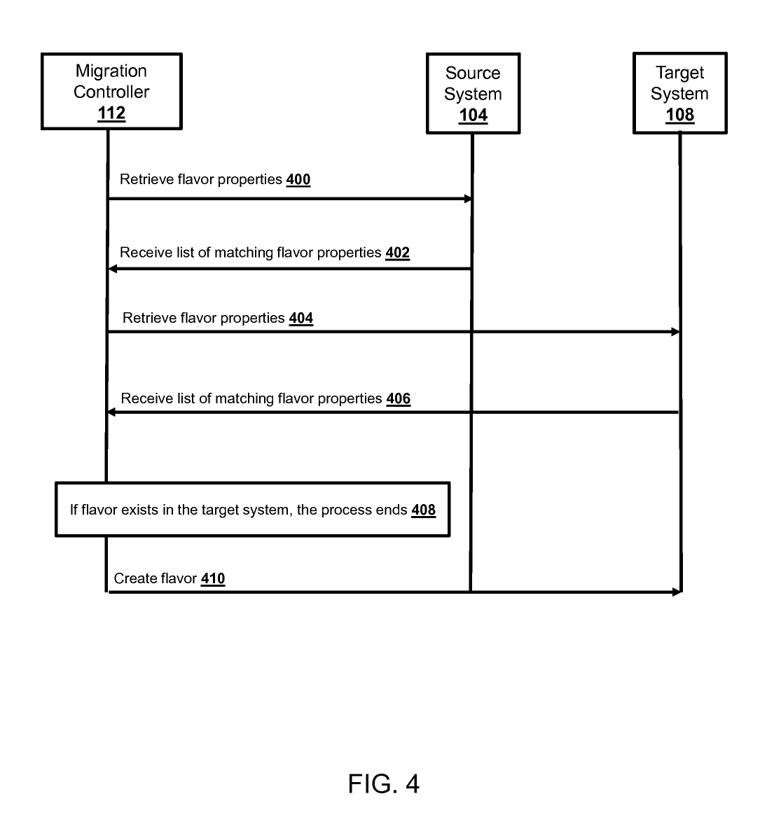

After receiving a list of requested VM properties, the migration controller performs a migration of flavor configuration (step 304), the image configuration (step 306), the KeyPair configuration (step 308), the volume configuration (step 310), and the port configuration (step 311). These configuration migrations are discussed in more detail in conjunction with FIG. 4-8.

After the migration of the various confirmations, the migration controller requests creation of a VM in the target system (step 312). Responsive to the request, the VM is created in the target system, as depicted in step 314. The VM created in the target system has similar or identical parameters as defined for flavor in the source system and the migration controller also connects the VM to the migrated configurations discussed in conjunction with FIG. 4-8. The migration controller configures the target system to receive new services by incoming hot migration as opposed to spawning a new server. For example, hot migration is a process, using for example, a migration controller, of transferring running or executing VMs between a hypervisor at a source system to a hypervisor at a target system while maintaining access to the storage, network connectivity, central processing unit state, and other states.

When generating the VM in the target system, the migration controller creates a VM according to a provided configuration (such as the migrated configurations discussed in FIG. 4-8), schedules the VM to a suitable host (such as one of hardware computing systems 110a-110n of target system 108), builds the VM according to the provided configuration, configures networking according to the provided configuration, performs block device mapping according to the provided configuration, and prepares a hypervisor in the target system for receiving a running VM through hot-migration from the source system.

As illustrated in steps 316, 318, 320, 322, 324, and 326, the source and the target system perform a series of steps including reading the VM configuration from a hypervisor in the source system (step 320). The migration controller awaits VM scheduling (step 316) and prepares the VM's hypervisor configuration for migration (step 324) by updating identities, names, and NICs to a configuration read from the target system. Finally, the source system writes the migration configuration (step 326).

Steps 330-334 depict the migration controller determining if the VM utilized shared storage. The migration controller performs the shared storage check by writing a file in a storage space accessible by the source system (step 330). The migration controller then checks the storage space accessible by the target system to determine if the file written in step 330 is accessible (step 332). Then, the migration controller deletes the file written in step 330 (step 334).

If the file written in step 330 was found in the storage space accessible by the target system, the migration controller determines that shared storage is present. The migration controller then re-links the storage space in the target system towards the storage space in the source system (step 336) and then relinks the newly-generated VM image towards the VM images in the source system (step 338). The migration controller then initiates hot-migration of the newly-generated VM to the target system using the shared storage and migration configuration from step 326 (step 340).

If the file written in step 330 was not found on the storage space accessible by the target system, the migration controller determines that there is no shared storage. The migration controller then moves and links the newly-generated VM image towards the source system's VM images (step 342) and initiates hot-migration of the newly-generated VM to the target system using block migration and the migration configuration from step 326 (step 344).

Finally, after the newly-generated VM has undergone hot migration, the target system awaits the VM execution on the configured host and sets the VM state to “Active/Running.”

FIG. 4 illustrates a more detailed method of migrating a VM flavor between a source system and a target system according to an embodiment of the present invention. FIG. 4 is a more detailed signal diagram of step 304 of FIG. 3A. As previously discussed, a VM flavor includes a description of a compute, memory, and storage capacity of a particular VM. The VM flavor specifies, for example, a number of virtual central processing units (VCPUs), an amount of random access memory (RAM), and amount of disk space for a root partition, an amount of disk space to use in an ephemeral disk partition, which is removed when the VM stops execution, an amount of swap disk space, an identifier (ID) of the flavor, and whether or not the flavor is publically accessible.

The process begins at step 400, which illustrates a migration controller (e.g., migration controller (e.g., migration controller 112 of FIG. 1A) requesting virtual machine (VM) properties from a source system (e.g., source system 104 of FIG. 1A). In response to the request from the migration controller, the source system returns a list of flavor properties available in the source system (step 402). Then, the migration controller requests flavor properties from a target system (e.g., target system 108 of FIG. 1A) (step 404). In response to the request, the target system returns a list of flavor properties available in the target system (step 406). If a particular flavor from the source system already exists in the target system, the process ends (step 408). If the flavor does not already exist in the target system, the migration controller creates a flavor in the target system with identical parameters as defined for flavor in the source system. The migration controller may have to translate between parameters recognized by the source system to parameters recognized by the target system.

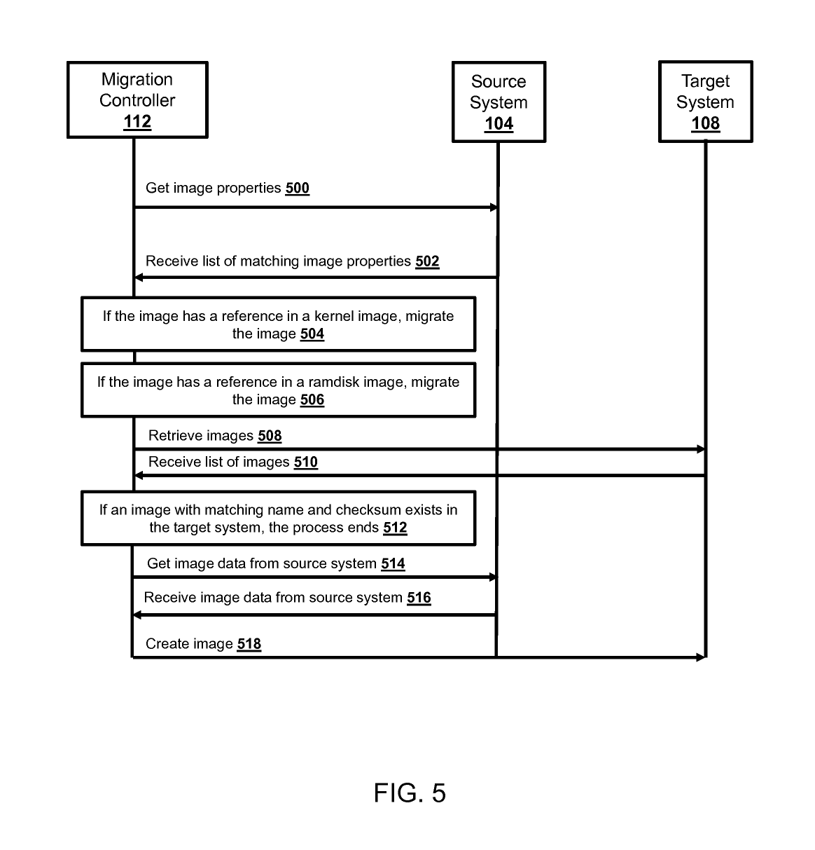

FIG. 5 illustrates a more detailed method of migrating a VM image between a source system and a target system according to an embodiment of the present invention. FIG. 5 is a more detailed signal diagram of step 306 of FIG. 3A. A virtual machine (VM) image is a file that includes a virtual disk that further includes an installed bootable operating system.

The process begins at step 500, where a migration controller (e.g., migration controller 112 of FIG. 1A) requests image properties from a source system (e.g., source system 104 of FIG. 1A). In response to the request, the source system returns a list of matching image properties (step 502). If the image has a reference to a kernel image (e.g., the kernel is responsible for managing system resources including, for example, the communication between hardware and software components), the migration controller migrates the image (step 504). If the image has a reference to a ramdisk image, the migration controller migrates the image (step 506). For example, the ramdisk image is a temporary file system used during a boot (startup) sequence to, for example, prepare a root file system to be mounted. In step 508, the migration controller retrieves images from a target system (e.g., target system 108 of FIG. 1A). In response to a request from the migration controller, the target system returns a list of images from the target system (step 510). If the migration controller determines that an image with a matching name and checksum already exists in the target system, the process ends (step 512). If the migration controller determines that an image with a matching name and checksum does not already exist in the target system, the migration controller requests and receives image data from the source system (steps 514-516). Finally, as shown in step 518, the migration controller creates an image as defined in the source system and uploads the image to the target system.

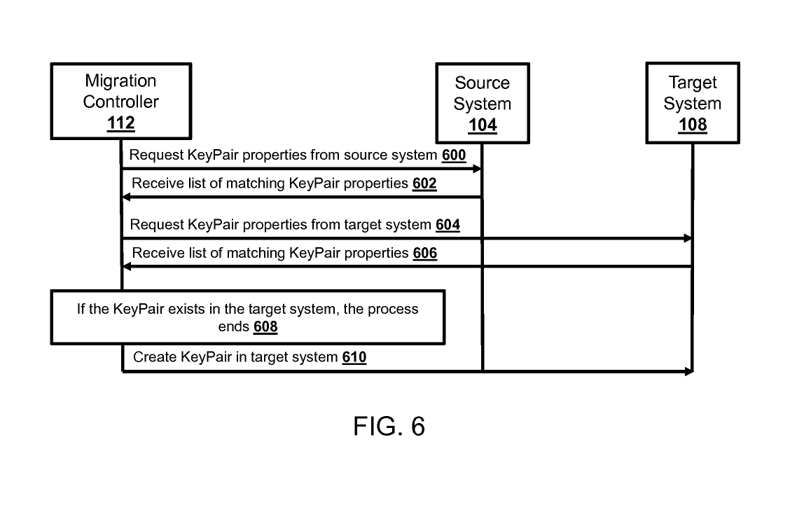

FIG. 6 illustrates a more detailed method of migrating a VM KeyPair (used for public key/private key encryption) between a source system and a target system according to an embodiment of the present invention. FIG. 6 is a more detailed signal diagram of step 308 of FIG. 3A.

The process begins at step 600, where a migration controller (e.g., migration controller 112 of FIG. 1A) request KeyPair properties from a source system (e.g., source system 104 of FIG. 1A). In response to the request, the source system returns a list of matching KeyPair properties (step 602). Then, the migration controller requests any matching KeyPairs from a target system (e.g., target system 108 of FIG. 1A) (step 604). In response to the request, the target system returns a list of any matching KeyPair properties (step 606). Based on the list of any matching KeyPair properties, if a KeyPair already exists in the target system, the process ends (step 608). If, however, a KeyPair does not already exist in the target system, the migration controller generates a KeyPair with identical parameters (e.g., name and public key) as defined for the KeyPair in the source system (step 610).

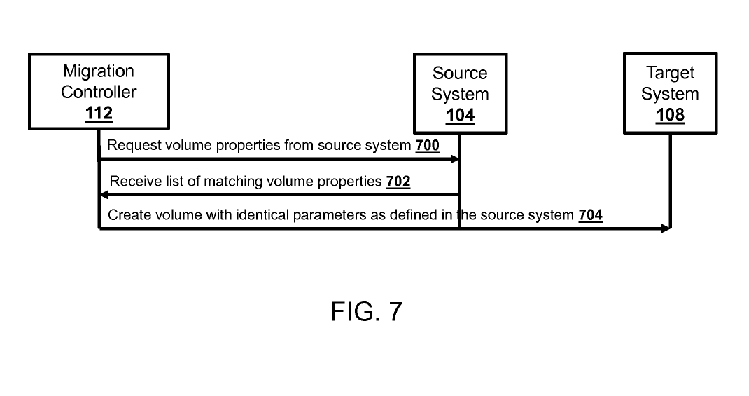

FIG. 7 illustrates a more detailed method of migrating a VM volume between a source system and a target system according to an embodiment of the present invention. FIG. 7 is a more detailed signal diagram of step 310 of FIG. 3A. A volume is a block storage device that can be attached to a VM to enable persistent storage,

The process begins at step 700, where a migration controller (e.g., migration controller 112 of FIG. 1A) requests volume properties from a source system (e.g., source system 104 of FIG. 1A). In response to the request, the source system returns a list of matching volume properties to the migration controller (step 702). The migration controller creates a volume in the target system with identical parameters as defined in the source system (step 704).

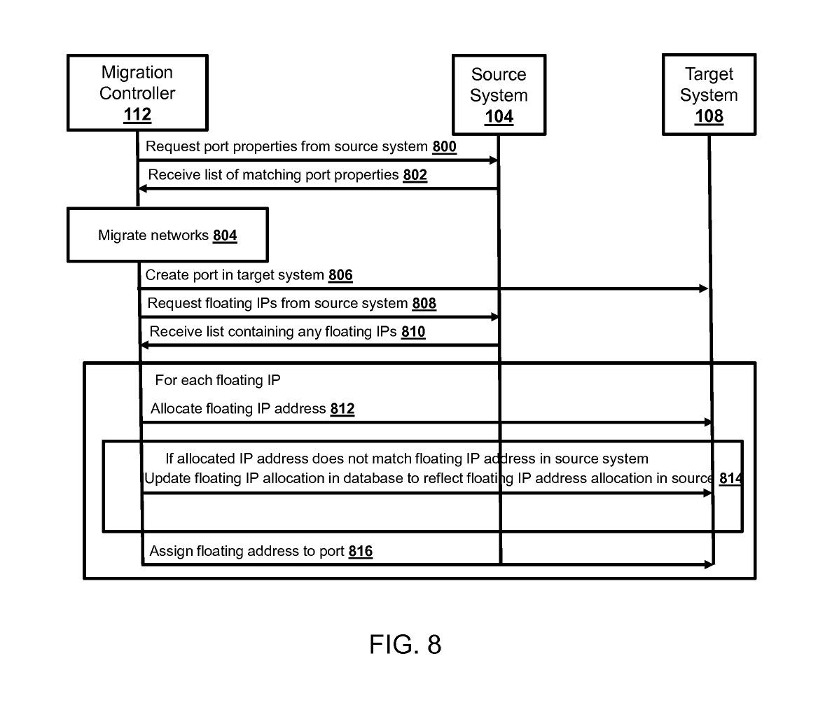

FIG. 8 illustrates a more detailed method of migrating VM port properties between a source system and a target system according to an embodiment of the present invention. FIG. 8 is a more detailed signal diagram of step 311 of FIG. 3A.

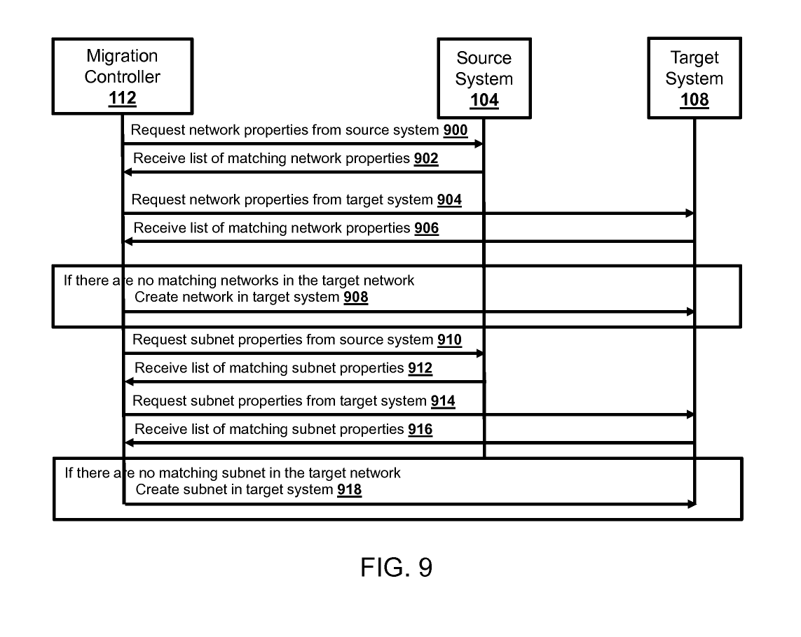

The process begins at step 800, where a migration controller (e.g., migration controller 112 of FIG. 1A) requests a list of port properties from a source system (e.g., source system 104 of FIG. 1A). In response to the request, the source system returns a list of port properties (step 802). The migration controller then migrates networks connected to the port (discussed in more detail in conjunction with FIG. 9) to a target system (e.g., target system 108 of FIG. 1A) (step 804). The migration controller then generates a port with identical parameters as defined in the source network in the target system (step 806). In step 808, the migration controller checks if there are any floating Internet Protocol (IP) addresses connected to the port from the source system. A floating IP is an IP address, often belonging to an external network, which can be dynamically associated and disassociated with a VM. In response to the check, the source system returns a list that includes any floating IP addresses (step 810). For each floating IP address, the migration controller allocates the floating IP address in the target system (step 812). If the allocated IP address does not match the floating IP address in the source system, the migration controller updates the floating IP allocation in a database to reflect the floating IP address allocation in the source system (step 814). Finally, in step 816, the floating IP address is assigned to the port in the target system.

FIG. 9 is a more detailed method of migrating networks between a source system and a target system according to an embodiment of the present invention. FIG. 9 is a more detailed signal diagram of step 804 of FIG. 8.

The process starts at step 900, where a migration controller (e.g., migration controller 112 of FIG. 1A) requests network properties from a source system (e.g., source system 104 of FIG. 1A). In response to the request, the source system returns a list of matching network properties (step 902). In order to check if a network with a matching virtual local area network (VLAN) tag (to enable cross network device communication for the same virtual network, a determination is made that the VLAN tags are identical) and name exists in a target system (e.g., target system 108 of FIG. 1A), the migration controller requests network properties from the target system (step 904). In response to the request, the target system returns a list of matching network properties (step 906). If there are no matching networks, the migration controller creates a network in the target system where the network has identical parameters as defined for the network in the source system (step 908). The process continues to step 910, where the migration controller requests subnet properties from the source system. In response to the request, the source system returns a list of matching subnet properties (step 912). The migration controller then requests subnet properties from the target system (step 914). The target system returns a list of matching subnet properties (step 916). If there are no matching subnets in the target network, the migration controller creates a subnet in the target system with identical parameters as defined for the subnet in the source system (step 918).

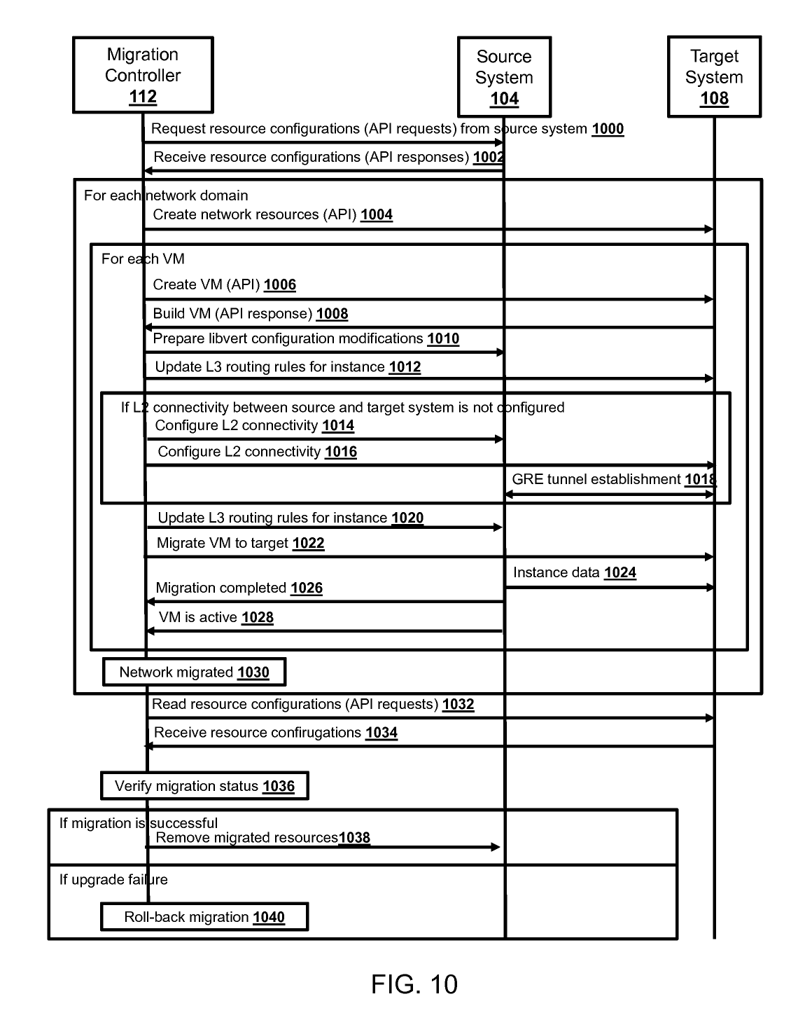

FIG. 10 illustrates another embodiment of migrating active resources between a source system and a target system. In this embodiment, a source system (e.g., source system 104 of FIG. 1A) is implemented as a source OpenStack instance and a target system (e.g., target system 108 of FIG. 1A) is implemented as a target OpenStack instance. A migration controller (e.g., migration controller 112 of FIG. 1A), after reading resource configurations in steps 1000 and step 1002 from the source system, determines a migration strategy. One aspect that affects a migration strategy is “resource dependency.” For example, a first resource (e.g., a first VM) is dependent on a second resource (e.g., a second VM) if the first resource is providing a certain service and the second resource is providing the same service, but is configured to be a backup to the first resource. It would be undesirable for both resources to be supported by a same physical host (e.g., hardware computing systems from FIG. 1A). If the physical host fails or requires downtime due to maintenance issues, both the primary and backup resources become unavailable, which will result in service outages.

Another issue that affects resource dependency is the physical capability of a particular physical host. If the physical host does not have enough processing power to support the migration of resources without performance degradation, it would be unsuitable to migrate VMs to that particular host.

After deciding on a migration strategy, the migration controller implements the migration strategy. For each network domain, the migration controller creates network resources in the target system (step 1004). For each resource (e.g., VM) to be migrated, the migration controller creates a VM in the target system (step 1006). The target system awaits incoming live VM migration instead of spawning a new VM. In step 1008, the target system notifies the migration controller when the VM has been created (step 1008). In step 1010, the migration controller prepares libvirt configuration modifications. The libvirt configuration includes configuration related to the execution of the VM, e.g., which virtual network interface(s) to which the VM should be connected. If these virtual network interfaces do not have the same identifiers on both the source and target systems, the configuration used for the execution of the VM on the source system must be modified to reflect the identifies used in the target system. The configuration is applied directly when the execution of the VM is moved to the target system. Then, in step 1012, the migration controller updates L3 routing rules for the VM in the target system.

If the L2 connectivity between the source and target systems are not configured, the migration controller configures the L2 connectivity between the source and target systems in steps 1014 and 1016. Then, the source system and target system establishes a generic routing encapsulation (GRE) tunnel to facilitate communication between the systems (step 1018).

In step 1020, the migration controller updates L3 routing rules for the VM. Then, the migration controller migrates the VM to the target system (step 1022). In step 1024, the VM data for the migrated VM is transferred between the source system and the target system. In steps 1026 and 1028, the source system reports to the migration controller that the migration is completed and that the VM is active. In step 1030, the migration controller facilitates the migration of any related networks (as described in FIG. 9).

In steps 1032 and 1034, the migration controller requests and receives the resource configurations from the target system. In step 1036, the migration controller verifies the migration status by removing the migrated resources (step 1038) from the source system if the migration was successful. If the migration was unsuccessful, the migration controller rolls back the migration by re-establishes, when necessary, the VM's connections in the source system and removes the migrated VM from the target system (step 1040).

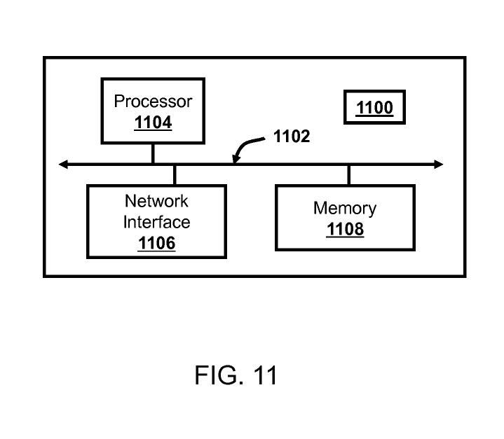

FIG. 11 illustrates a data processing system according to an embodiment of the present invention. As illustrated in FIG. 11, the data processing system 1100 includes at least one processor 1104 that is coupled to a network interface 1106 via an interconnect 1102. A memory 1108 can be implemented by a hard disk drive, flash memory, read-only memory, local or remotely mounted memory and stores computer-readable instructions. The at least one processor 1104 executes the computer-readable instructions and implements the functionality described above. Network interface 1106 enables the data processing system to communicate with other data processing systems within the network. For example, data processing system 1100 can be used to implement network node 102, hardware computing systems 106a-106n, and/or hardware computing systems 110a-110n. Alternative embodiments of the present invention may include additional components responsible for providing additional functionality, including any functionality described above and/or any functionality necessary to support the solution described above.

As will be recognized by those skilled in the art, the innovative concepts described in the present application can be modified and varied over a wide range of applications.

What is claimed is:

1. A method, performed by a migration controller implemented by at least one processor executing computer-readable instructions stored on a memory, wherein the computer-readable instructions are configured for:
identifying at least one resource to be migrated from a source system to a target system,
creating at least one resource in the target system with similar properties as the at least one resource to be migrated from the source system; and
migrating the at least one resource from the source system to the target system.

2. The method according to claim 1, wherein the computer-readable instructions are further configured for:
determining at least one property of the at least one resource to be migrated from the source system.

3. The method according to claim 2, wherein the computer-readable instructions are further configured for:
translating the at least one property of the at least one resource to be migrated from the source system to at least one property recognized by the target system.

4. The method according claim 1, wherein the computer-readable instructions are further configured for:
determining at least one resource dependency between the at least one resource to be migrated from the source system and at least one other resource from the source system.

5. The method according to claim 4, wherein the computer-readable instructions are further configured for:
in response to determining the at least one resource dependency between the at least one resource to be migrated from the source system and at least one other resource from the source system, determining a migration strategy based on the at least one resource dependency.

6. The method according to claim 1, wherein the source system is managed by a first cloud computing platform and the target system is managed by a second cloud computing platform.

7. The method according to claim 6, wherein the first cloud computing platform and the second cloud computing platform are different cloud computing platforms.

8. The method according to claim 6, wherein the first cloud computing platform and the second cloud computing platform are different versions of the same cloud computing platform.

9. The method according to claim 6, wherein the first cloud computing platform and the second cloud computing platform are the same cloud computing platform.

10. The method according to claim 1, wherein the computer-readable instructions are further configured for:
in response to determining a migration is completed, removing, from the source system, the at least one resource to be migrated from the source system.

11. An apparatus comprising:
at least one processor,
a memory further including computer-readable instructions, when executed by the at least one processor, are further configured for:
identifying at least one resource to be migrated from a source system to a target system;
creating at least one resource in the target system with similar properties as the at least one resource to be migrated from the source system; and
migrating the at least resource from the source system to the target system.

12. The apparatus according to claim 11, wherein the computer-readable instructions are further configured for:
determining at least one property of the at least one resource to be migrated from the source system.

13. The apparatus according to claim 12, wherein the computer-readable instructions are further configured for:
translating the at least one property of the at least one resource to be migrated from the source system to at least one property recognized by the target system.

14. The apparatus according to claim 11, wherein the computer-readable instructions are further configured for:
determining at least one resource dependency between the at least one resource to be migrated from the source system and at least one other resource from the source system.

15. The apparatus according to claim 14, wherein the computer-readable instructions are further configured for:
in response to determining the at least one resource dependency between the at least one resource to be migrated from the source system and at least one other resource from the source system, determining a migration strategy based on the at least one resource dependency.

16. The apparatus according to claim 11, wherein the source system is managed by a first cloud computing platform and the target system is managed by a second cloud computing platform.

17. The apparatus according to claim 16, wherein the first cloud computing platform and the second cloud computing platform are different cloud computing platforms.

18. The apparatus according to claim 16, wherein the first cloud computing platform and the second cloud computing platform are different versions of the same cloud computing platform.

19. The apparatus according to claim 16, wherein the first cloud computing platform and the second cloud computing platform are the same cloud computing platform.

20. The apparatus according to claim 11, wherein the computer-readable instructions are further configured for:
in response to determining a migration is completed, removing, from the source system, the at least one resource to be migrated from the source system.
